(19) United States
(12) Patent Application Publication
(10) Pub. No.: US 2007/0206033 A1
(43) Pub. Date: Sep. 6, 2007

(54) All-in-one recordable card

(76) Inventor: Michael Raymond Willis, Savannah, GA (US)

Correspondence Address: Michael Raymond Willis, 407 Willow Rd, Savannah, GA, 31419, US

(21) Appl. No.: 11/364,190

(22) Filed: Mar. 1, 2006

(51) Int. Cl. G01D 9/00

(52) U.S. Cl. 346/25

(57) ABSTRACT

A relatively thin and flat recordable for recording, storing and play back of audible messages. Audio recording/reproducing device contained in card consists of at least a circuit board, microphone, speaker, power supply, record control button and play control button. Removable tab makes recorded greeting permanent when removed. Card also provides an image area to further personalize card with illustration.

### FIELD OF THE INVENTION

The present invention relates to recordable cards and, more particularly, to recordable cards that do not require a separate device for recording and have the ability to make a message permanent.

### BACKGROUND OF THE INVENTION

For more than 200 years the world has conveyed their sentiment to each other with greeting cards. The original form of greeting cards were postcard style usually with illustration and text on one side and space for address or written text on the other. Over time postcards were no longer referred to as greeting cards and began being used to depict people, places and things of interest. Although postcards are more convenient to carry, store and select they are generally only used when people are away from home as a way of saying hello.

As the greeting card industry grew a new style of card was introduced that has become the standard in greeting cards. Folded cards, usually with illustration and text on the card exterior and additional text on the card interior, became the new standard greeting card.

There is an ever growing need for a larger selection of cards to suit the lifestyles and situations of today. As the selection of cards increases so does the amount of time it takes to select the most appropriate card. Pre-printed cards seldom express exactly what the consumer is attempting to convey. Which causes consumers to spend an exorbitant amount of time searching for the perfect card, quite often without success. Standard greeting cards are also unable to accommodate those who are unable to read without assistance from someone else.

The greeting card industry requires a substantial amount of space in retail outlets to display greeting cards. Greeting card companies are unable to display greeting cards in the smaller retail establishments because they are unable to offer cards that require less space. Because of this, consumers are unable to purchase a card at the convenient store or gas station.

In the fast paced world of today consumers want to make their purchase the quickest, easiest way possible without losing the personal touch. While pre-printed cards may somewhat convey your sentiment they can never replace the sound of your voice. Everyone speaks with a different tone, accent or even language. When consumers send mass produced pre-printed cards they are sending a card that countless others will also send because it lacks a more personal touch. When consumers are given the opportunity to express their sentiments without pre-printed words, the possible uses for recordable cards would be substantial.

When someone receives a greeting card they either place the card in an old shoe box or similar container as a keepsake or place it in a trash receptacle. While most people choose to save their cards very few will take the time to search through and read countless cards to find a particular one. There are not cards available that can be stored and reviewed easily because of text on the back or interior of the card.

In reviewing prior art devices most require the use of a separate machine, computer or telephone to record greeting. There is not a prior art device available that addresses all of the problems in creating a relatively thin and flat recordable card that combines ease of operation, ease of selection, the ability to disable record function, and is convenient for carrying, storage and review.

U.S. Pat. No. 4,791,741 to Kondo for CARD WITH BUILT-IN RECORD/PLAYBACK CAPABILITY is capable of recording and playing messages, has multiple uses and is easy to carry or store.

This card has the necessary functions, but makes the process more difficult than necessary for the user by requiring user to switch back and forth between record and play selections and then requires insertion of a pin to perform chosen function. A message on this card can never be permanent because it offers no protection against erasing the message.

It is therefore an object of the invention to provide a recordable card with multiple uses.

It is another object of the invention to provide a recordable card that can be further personalized by consumer with art or pictures.

It is another object of the invention to provide a recordable card that is relatively thin and flat for easy carrying, storage and review.

It is another object of the invention to provide a recordable card with the ability to make a recorded greeting that is permanent.

It is another object of the invention to provide a more personalized way to convey thoughts and feelings.

It is another object of the invention to provide a recordable card that makes card selection easier to accommodate busier lifestyles of today.

### SUMMARY OF THE INVENTION

In accordance with the present invention, there is provided a relatively thin and flat recordable card to record and play audible messages with an upper and lower surface affixed together to conceal a record and play device, having an opening in upper surface for access of sound to microphone and access of sound from speaker as well as openings for access to record and play functions with a removable tab on side of card to disable record function once satisfied with greeting and space on upper surface for illustration.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front detail view of an all-in-one recordable card which illustrates a preferred embodiment in accordance with the invention; and

FIG. 2 is a side plan view of an all-in-one recordable card in accordance with the invention.

For purposes of clarity and brevity, like elements and components will bear the same designations and numbering throughout the Figures.

### DESCRIPTION OF THE PREFERRED EMBODIMENT

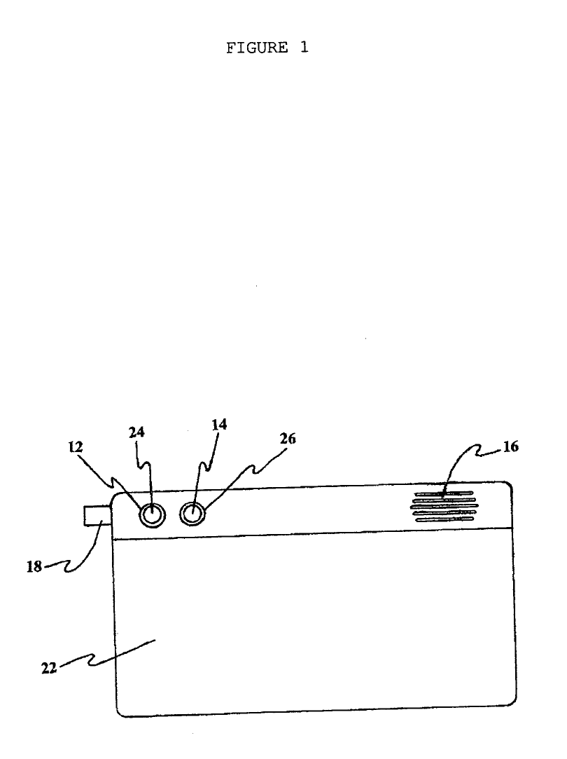

FIG. 1 illustrates the preferred embodiment of this invention which will be described below in reference to the drawings.

Contained in there between the upper surface 10, and the lower surface 20, is an audio recording and reproducing device (not shown). The audio recording and reproducing device consists of at least a circuit board, microphone, speaker, power supply, record control button and play control button. Although the audio recording and reproducing device is not shown in the drawings, anyone with ordinary skill in the art will understand the device and it's function.

Holes 12 and 26 are respectively made on upper surface 10 at locations corresponding to the play button 14 and record button 24. Opening 16 is respectively made on upper surface 10 at a location corresponding to the microphone and speaker.

Record button 24 partially projects into 1st hole 12 on upper surface 10 of said card. User activates the record function by depressing record button 24 and speaking into microphone (not shown) which is accessed through opening 16 on upper surface 10 for subsequent processing and storing in memory. If user is satisfied with greeting when played back, user then pulls out removable tab 18, thereby severing connection of record button 24 from the circuit board of audio recording and reproducing device. When removable tab 18 is removed, the record button 24 no longer performs any function when depressed and recorded greeting becomes permanent, preventing any further erasing of message. If user is not satisfied with greeting when played back, the user may again depress the record button 24 and re-record message by again speaking into opening 16. The act of re-recording overwrites the previously stored message. Thus, the user may re-record a message as many times as necessary until the message is satisfactory.

Play button 14 partially projects into 2nd hole 26 on upper surface 10 of said card. User initiates audio message playback through speaker, by depressing play button 14 and listening to recorded audio message. Recorded audio message is heard by means of the speaker (not shown) which is located below opening 16 on the upper surface 10 of said card.

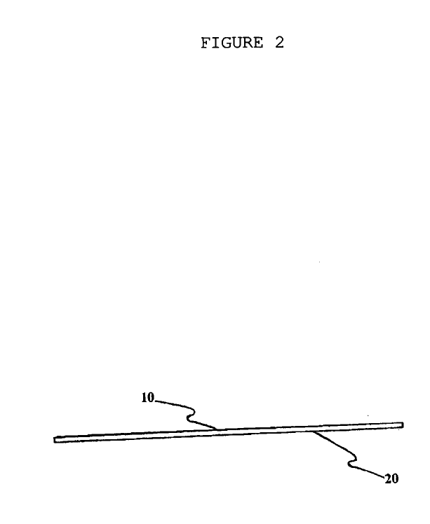

FIG. 2 illustrates the upper surface 10 and lower surface 20 securely fused together. Whereas separation would result in breakage of said card. Upper surface 10 and lower surface 20 may be constructed of, plastic or other suitable lightweight material.

Upper surface 10 and previously described attributes are the front of said card when attached to lower surface 20 of card which is to be considered the back of said card.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An all-in-one recordable card for recording and playing audible messages, comprising:
means for providing upper half of stabilization for card;
means for providing lower half of stabilization for card, securely fused to said means for providing upper half of stabilization for card;
means for activating the audio recording/reproducing device to record audio messages by means of the microphone;
means for activating the audio recording/reproducing device to play back recorded audio message stored in memory through the speaker;
means for access to microphone for receiving audio information and, for listening to audio information stored in memory to be heard from speaker;
means for disabling record capability to make recorded greeting permanent;
means for providing illustration or pictures to further personalize card;
means for access to record button;
means for access to play button; and
means for recording and play back of audio messages.

2. The all-in-one recordable card in accordance with claim 1, wherein said means for activating the audio recording/reproducing device to record audio messages by means of the microphone comprises a record button.

3. The all-in-one recordable card in accordance with claim 1, wherein said means for activating the audio recording/reproducing device to play back recorded audio message stored in memory through the speaker comprises a play button.

4. The all-in-one recordable card in accordance with claim 1, wherein said means for disabling record capability to make recorded greeting permanent comprises a removable tab.

5. The all-in-one recordable card in accordance with claim 1, wherein said means for recording and play back of audio messages comprises an audio recording/reproducing device.
